(19) United States
(12) Patent Application Publication
(10) Pub. No.: US 2024/0356766 A1
(43) Pub. Date: Oct. 24, 2024

(54) ARCHITECTURE OF CLOUD COMPUTING ORIENTED HIGH-PERFORMANCE BLOCKCHAIN

(71) Applicant: SHANDONG UNIVERSITY, Qingdao (CN)

(72) Inventors: Dongxiao YU, Qingdao (CN); Jinfeng DOU, Qingdao (CN); Minghui XU, Qingdao (CN); Shuo LIU, Qingdao (CN); Yifei ZOU, Qingdao (CN)

(21) Appl. No.: 17/754,516

(22) PCT Filed: Mar. 10, 2021
(86) PCT No.: PCT/CN2021/080021

§ 371 Date: Apr. 4, 2022

(30) Foreign Application Priority Data
Mar. 2, 2021 (CN) 202110229853.2

(51) Int. Cl. H04L 9/00

(52) U.S. Cl. CPC H04L 9/50

(57) ABSTRACT

The present disclosure provides an architecture of a cloud computing oriented high-performance blockchain including a cloud computing oriented blockchain network architecture and a cloud computing oriented blockchain system architecture; wherein the cloud computing oriented blockchain network architecture enables each blockchain node to be directly connected to an RDMA, and to bypass an operating system kernel and directly communicate with a network card in a high efficiency communication mode; and the cloud computing oriented blockchain system architecture includes a network layer, a consensus layer, and a blockchain layer. According to the present disclosure, network communication is implemented by the RDMA, and a block broadcasting speed is improved, and a block synchronization latency is shortened.

### TECHNICAL FIELD

The present disclosure relates to the field of computer technologies, and in particular, relates to an architecture of a cloud computing oriented high-performance blockchain.

### BACKGROUND

A blockchain is a comprehensive innovative application integrating distributed consensus, cryptography, peer-to-peer network, distributed data storage, and the like computer technologies. Core advantages of the blockchain is decentralization, anti-counterfeiting, and traceability. An edge and end-based blockchain system is subject to some security issues. Since a terminal has a limited capability to perceive a device, anti-virus software, firewalls, intrusion detection, and defense systems fail to be established, and no mature cryptographic library protection mechanism is developed. This is unfavorable to maintaining consistent security and reliability for the device. The edge and end-based system is practically poorer than a cloud-end system in terms of performance, including storage and computation. Therefore, in an industrial scenario, a high-density Internet of things devices may generate a large amount of authentication and lodger data. As such, a higher requirement is imposed to a storage and computation space of the edge and end of the blockchain, and thus a data anti-expansion algorithm is desired in the blockchain architecture. Patent application No. CN201980004299.9 has designed a method and system for automatically deploying blockchains based on a cloud platform. A virtual computation environment is created in a computer, and the computer is connected to a cloud platform; an initial block of a blockchain is generated, and the initial block of the blockchain is transmitted to the cloud platform; the blockchain is made to be initialized in the virtual computation environment; and upon completion of initialization of the blockchain, the blockchain is monitored based on the cloud platform. This solution is a BaaS-based blockchain deployment solution. The cloud computing oriented blockchain system according to this patent application may solve the security problem in the edge and end blockchains, and address restrictions in storage and the like. However, some limitations are still present, for example, excessive CPU scheduling, low-efficiency block broadcasting, a high latency of synchronization of the initial block in the case that a new node is added to the blockchain network, and the like. At present, the cloud-based blockchain deployment solution still has a low efficiency, and the blockchain system suitable for edge and end deployment is still used, only with the deployment position changed. However, no dedicated blockchain, system architecture, or consensus algorithm is designed for the cloud computing. In addition, the application scenario is monotonous, and situations where blockchains are deployed for individual enterprises are not considered.

### SUMMARY

In view of the above problem, the present disclosure provides a novel blockchain network architecture constructed based on an RDMA technology, which provides a shared memory for a user, and designs a consensus algorithm with Byzantine fault tolerance based on the shared memory, such that a cloud computing oriented high-performance blockchain system is achieved. By using RDMA data zero copy, kernel bypass, remote no CPU participation, and the like merits, a consensus achievement speed and a block acknowledgment speed are greatly improved, and a synchronization latency of blockchain data is shortened. The technical solutions are as follows:

An architecture of a cloud computing oriented high-performance blockchain includes a cloud computing oriented blockchain network architecture and a cloud computing oriented blockchain system architecture; wherein
the cloud computing oriented blockchain network architecture enables each blockchain node to be directly connected to an RDMA, and to bypass an operating system kernel and directly communicate with a network card; and
the cloud computing oriented blockchain system architecture includes a network layer, a consensus layer, and a blockchain layer;
wherein the network layer provides a communication service for the consensus layer, the consensus layer is provided with a blockchain consensus algorithm designed based on a shared memory and is configured to reach consensus for a new proposed block, and the blockchain layer is configured to store data and maintain system data stability.

Preferably, the network layer includes an RDMA code library, a fundamental communication API, and a link manager; wherein the RDMA code library provides a fundamental technical support for the RDMA and defines a function for a remote memory access, the fundamental communication API is a communication mode of a blockchain with respect to the RDMA and specifies a uniform communication interface to instantiate the RDMA code library, and the link manager is configured to manage a communication channel between the blockchain nodes.

Preferably, the consensus layer includes a cryptographic library, a shared memory manager, and a blockchain consensus kernel; wherein the cryptographic library supports a fundamental cryptographic function for the blockchain and ensures security of the blockchain, and the shared memory manager is configured to establish, use, and destroy a shared memory.

Preferably, the blockchain layer includes a wallet, a client, and a blockchain database; wherein the wallet is a storage space of a blockchain digital asset and is configured to notify a user of account balance and digital asset status information, the client is configured to transceive a transaction, provide a front-end operation interface, and perform simple identity verification, and the blockchain database is configured to store data desired by the blockchain, including blockchain ledger data and status data.

Preferably, based on a consensus protocol, each blockchain node acquires, by using the shared memory manager, its shared memory region mᵢ from a cloud server, and acquires a highest authority of for performing read and write operations; any other nodes other than a node i are only allowed to read; instead of modifying data in mᵢ; and the operations are collaboratively performed by the cryptographic library and the shared memory manager.

Preferably, a consensus process includes leadership election, block generation, block verification and voting, and block chaining; wherein
in the leadership election, the nodes are required to collaboratively execute a shared memory-based leadership election algorithm, and ensures only one node to win in this election, and a leader is responsible for leading a subsequent consensus process;
in the block generation, upon completion of the leadership election, the leader packages a transaction and generates a block, and writes the block into a shared memory region, and the other nodes are allowed to read the shared memory region to acquire block information;
in the block verification and voting, upon acquiring the block information, the other nodes other than the leader performs correctness verification for the block, in the case that the block is correct, multiple turns of voting are carried out for the block, and finally an agreement indicative of acceptance or discard is reached for the blockchain; and
in the block chaining, upon achievement of the consensus, in the case that the consensus indicates acceptance, a new block is stored into a blockchain database and related information is updated, and otherwise, the block is discarded and the process enters a next turn.

Preferably, system deployment includes the following steps:

S1. establishing a system running environment;

S2. registering blockchain nodes;

S3. configuration of the blockchain nodes: shared memory regions are assigned to the newly registered blockchain nodes, and the configured blockchain node participates in a consensus process; in each turn of consensus achievement, the blockchain nodes elect a primary node using a shared memory-based leadership election algorithm, finally only one blockchain node successfully wins as the primary node and a block is generated, and the other blockchain nodes verify and vote for the block; the blockchain nodes in the system collaboratively decide whether to chain the block onto the blockchain based on a voting result, and in the case that a chaining condition is satisfied, the blockchain is updated locally and the system enters a next turn of consensus achievement.

### Beneficial Effects

1) The architecture of the cloud computing oriented high-performance blockchain implements network communication by the RDMA, such that a block broadcasting speed is improved, and a block synchronization latency is shortened.
2) A blockchain consensus protocol based on the shared memory is designed, and a corresponding consensus achievement procedure is proposed with respect to a model. A a consensus mechanism with low power consumption and high reliability is designed, such that node resources are maximally utilized, and an even higher throughput and an even lower latency are achieved.
3) A complete cloud-based high-performance blockchain system deployment and running procedure are designed.

### Term Interpretation

Blockchain: The blockchain is a comprehensive innovative application integrating distributed consensus, cryptography, peer-to-peer network, distributed data storage, and the like computer technologies. Core advantages of the blockchain is decentralization, anti-counterfeiting, and traceability. The blockchain, in combination with the cryptographic technology, the distributed consensus mechanism, and the economic award model, allows various nodes involved in the chain communicate and cooperate with each other even without trusting each other, such that a trustable computing environment is provided, which provides a new solution to single-point faults, untrusted data storage and the like problems.

Consensus mechanism: The consensus mechanism is one of the core technologies in the blockchain. The consensus mechanism refers to an algorithm that helps various nodes to reach a consensus on sequences of events within the same time period in a whole distributed system. This mechanism ensures consensus achievements with respect to all newly generated blocks in a whole blockchain network, so as to ensure consistency of the blockchains.

Cloud computing: The cloud computing is essentially an aggregation of various remote computation resources and services. The cloud computing abstracts data computation, data storage, network transmission, hardware devices and the like resources by virtualization, distributed and parallel processing and the like critical technologies, and hence dynamically provides these resources to users based on demands. The cloud computing is a pay service, and users need to purchase corresponding cloud computing services according to actual needs on the premise of sufficient evaluation. This provides users with a more flexible, convenient, and economic fashion to dynamically acquire computation resources and storage resources according to actual needs.

Remote direct memory access (RDMA) technology: Using the RDMA technology based on hardware supports, user status data of remote nodes may be directly accessed, and the TCP/IP protocol stack may be bypassed. In addition, no remote host CPU is desired, such that overhead caused by communication of nodes in a cluster may be effectively reduced, utilization of network bandwidth may be maximized, and overall processing capabilities of the cluster system may be improved.

### BRIEF DESCRIPTION OF THE DRAWINGS

FIG. 1 illustrates an RDMA communication mode;

FIG. 2 illustrates a network architecture of a cloud computing oriented blockchain;

FIG. 3 illustrates a system architecture of a cloud computing oriented blockchain;

FIG. 4 illustrates an RDMA architecture based on shared storage; and

FIG. 5 illustrates a procedure of system deployment.

### DETAILED DESCRIPTION

The detailed descriptions hereinafter are exemplary and illustrative, and are intended to further illustrate the present application. Unless otherwise specified, all the technical and scientific terms used herein have the same meanings as those within common understandings of persons of ordinary skill in the art of the present disclosure. It should be noted that the terms used herein are only intended to describe the specific embodiments, instead of causing any limitation to the exemplary embodiments of the present disclosure.

An architecture of a cloud computing oriented high-performance blockchain includes a cloud computing oriented blockchain network architecture and a cloud computing oriented blockchain system architecture; wherein

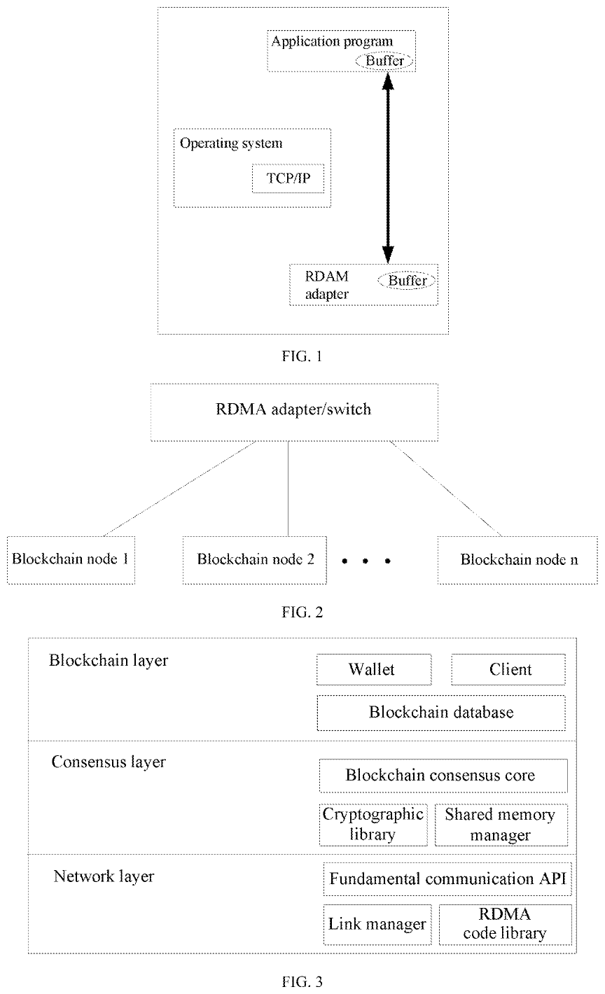

The cloud computing oriented blockchain network architecture enables each blockchain node to be directly connected to an RDMA, and to bypass an operating system kernel and directly communicate with a network card. An RDMA communication is as illustrated in FIG. 1. As compared with the traditional TCP/IP network card, the RDMA network card does not require participation of a kernel (CPU), and all the data is directly transmitted from an application program to the network card.

As illustrated in FIG. 2, in a cloud service oriented network architecture, various blockchain nodes (also referred to as cloud nodes) are directly connected to the RDMA, and are capable of bypassing an operating system kernel and directly communicating with the network card in a high efficiency communication mode. Network communication to which the RDMA is introduced may achieve, by virtue of a performance-lossless network of the RDMA, the high-bandwidth and zero-copy technology to reduce system interruptions and memory copies and hence achieve an ultra-low latency.

The cloud computing oriented blockchain system architecture includes a network layer, a consensus layer, and a blockchain layer, as illustrated in FIG. 3.

Network layer The network layer mainly includes an RDMA code library, a fundamental communication API, and a link manager. The RDMA code library provides a fundamental technical support for the RDMA and defines all functions for a remote memory access; the fundamental communication API is a communication mode of a blockchain with respect to the RDMA and specifies a uniform communication interface to instantiate the RDMA code library, for example, read and write operations for a remote memory, and the like; and the link manager is configured to manage a communication channel between the blockchain nodes, and support establish, add, and delete operations for the channel. The network layer provides fundamental communication services for the consensus layer.

Consensus layer: A blockchain consensus kernel is a blockchain consensus algorithm desired based on the shared memory, and is configured to reach an agreement on a newly proposed block. The consensus layer mainly includes a cryptographic library, a shared memory manager, and a blockchain consensus kernel. The cryptographic library supports a fundamental cryptographic function for the block chain, for example, a hash function, a digital signature, or the like. The cryptographic library ensures security of the blockchain; and the shared memory manager is configured to establish, use, and destroy a shared memory.

Blockchain layer: The blockchain layer is configured to store data, and maintain data stability of the system. The blockchain layer mainly includes a wallet, a client, and a blockchain database. The wallet is a storage space of a blockchain digital asset and is configured to notify a user of account balance and digital asset status information, the client is configured to transceive a transaction, provide a front-end operation interface, and perform simple identity verification, and the blockchain database is configured to store data desired by the blockchain, including, but not limited to, blockchain ledger data, status data, and the like.

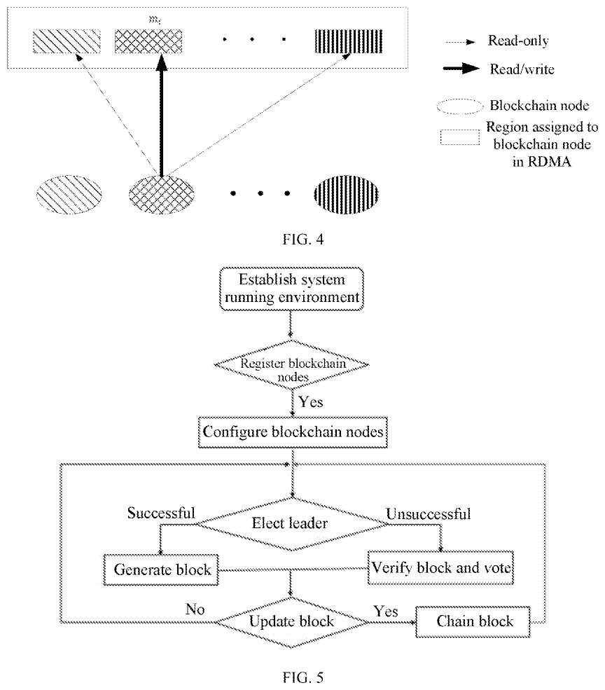

The shared memory-based blockchain consensus protocol is executed by the consensus layer. Each blockchain node acquires, by using the shared memory manager, its shared memory region mᵢ from a cloud server (in FIG. 4, regions having the same padding content represent the shared memory regions acquired by the blockchain nodes), and acquires a highest authority of mᵢ for performing read and write operations; and any other nodes other than a node i are only allowed to read mᵢ instead of modifying data in mᵢ. The above operations are performed by the cryptographic library and the shared memory manager collaboratively, as illustrated in FIG. 4.

A blockchain consensus kernel is responsible for a consensus process of a new blockchain. The consensus process includes leadership election, block generation, block verification and voting, and block chaining; wherein The specific process includes:
1) In the leadership election, the nodes are required to collaboratively execute a shared memory-based leadership election algorithm, and ensures only one node to win in this election, and a leader is responsible for leading a subsequent consensus process.
2) In the block generation, upon completion of the leadership election, the leader packages a transaction and generates a block, and writes the block into a shared memory region; and the other nodes are allowed to read the shared memory region to acquire block information.
3) In the block verification and voting, upon acquiring the block information, the other nodes other than the leader performs correctness verification, in the case that the block is correct, multiple turns of voting are carried out for the block, and finally an agreement indicative of acceptance or discard is reached for the block. The voting herein may be performed using any suitable type of conventional consensus algorithm, and different grades of fault tolerances may be provided according to application requirements.
4) In the block chaining, upon achievement of the consensus, in the case that the consensus indicates acceptance, a new block is stored into a blockchain database and related information is updated; and otherwise, the block is discarded and the process enters a next turn.

As illustrated in FIG. 5, a system deployment method for a cloud computing oriented high-performance blockchain architecture includes the following steps:

In S1, a system running environment is established, which may be Linux/Windows/Mac OS or the like operation system, or Docker/Kubernetes or the like application container engine.

In S2, blockchain nodes are registered, and the system may allocate resources for nodes registered as the blockchain nodes.

In S3, the blockchain nodes are configured. Shared memory region is assigned to the newly registered blockchain nodes, and the configured blockchain nodes participates in a consensus process; in each turn of consensus achievement, the blockchain nodes elect a primary node using a shared memory-based leadership election algorithm, finally only one blockchain node successfully wins as the primary node and a block is generated, and the other blockchain nodes verify and vote for the block; and the blockchain nodes in the system collaboratively decide whether to chain the block onto the blockchain based on a voting result, and in the case that a chaining condition is satisfies, the blockchain is updated locally and the system enters a next turn of consensus achievement.

Described above are merely preferred embodiments of the present application, but are not intended to limit the present application. A person skilled in the art may derive various modifications and variations. Any modification, equivalent replacement, or improvement made without departing from the spirit and principle of the present application should fall within the protection scope of the present application.

1. An architecture of a cloud computing oriented high-performance blockchain, comprising a cloud computing oriented blockchain network architecture and a cloud computing oriented blockchain system architecture; wherein
the cloud computing oriented blockchain network architecture enables each blockchain node to directly communicate with an RDMA, and to bypass an operating system kernel and directly communicate with a network card; and
the cloud computing oriented blockchain system architecture comprises a network layer, a consensus layer, and a blockchain layer;
wherein the network layer provides a communication service for the consensus layer, the consensus layer is provided with a blockchain consensus algorithm designed based on a shared memory and is configured to reach consensus for a new proposed block, and the blockchain layer is configured to store data and maintain system data stability.

2. The architecture of the cloud computing oriented high-performance blockchain according to claim 1, wherein the network layer comprises an RDMA code library, a fundamental communication API, and a link manager; wherein the RDMA code library provides a fundamental technical support for the RDMA and defines a function for a remote memory access, the fundamental communication API is a communication mode of a blockchain with respect to the RDMA and specifies a uniform communication interface to instantiate the RDMA code library, and the link manager is configured to manage a communication channel between nodes.

3. The architecture of the cloud computing oriented high-performance blockchain according to claim 1, wherein the consensus layer comprises a cryptographic library, a shared memory manager, and a blockchain consensus kernel; wherein the cryptographic library supports a fundamental cryptographic function for the blockchain, and the shared memory manager is configured to establish, use, and destroy a shared memory.

4. The architecture of the cloud computing oriented high-performance blockchain according to claim 1, wherein the blockchain layer comprises a wallet, a client, and a blockchain database; wherein the wallet is a storage space of a blockchain digital asset and is configured to notify a user of account balance and digital asset status information, the client is configured to transceive a transaction, provide a front-end operation interface, and perform identity verification, and the blockchain database is used to store data desired by the blockchain.

5. The architecture of the cloud computing oriented high-performance blockchain according to claim 3, wherein based on a consensus protocol, each blockchain node acquires, by using the shared memory manager, its shared memory region mᵢ from a cloud server, and acquires a highest authority of mᵢ for performing read and write operations: and any other nodes other than a node i are only allowed to read mᵢ instead of modifying data in mᵢ; and the operations are collaboratively performed by the cryptographic library and the shared memory manager.

6. The architecture of the cloud computing oriented high-performance blockchain according to claim 1, wherein a consensus process comprises leadership election, block generation, block verification and voting, and block chaining; wherein
in the leadership election, the nodes are required to collaboratively execute a shared memory-based leadership election algorithm, and ensures only one node to win in this election, and a leader is responsible for leading a subsequent consensus process;
in the block generation, upon completion of the leadership election, the leader packages a transaction and generates a block, and writes the block into a shared memory region, and the other nodes are allowed to read the shared memory region to acquire block information;
in the block verification and voting, upon acquiring the block information, the other nodes other than the leader performs correctness verification for the block, in the case that the block is correct, multiple turns of voting are carried out for the block, and finally an agreement indicative of acceptance or discard is reached for the blockchain; and
in the block chaining, upon achievement of the consensus, in the case that the consensus indicates acceptance, a new block is stored into a blockchain database and related information is updated, and otherwise, the block is discarded and the process enters a next turn.

7. The architecture of the cloud computing oriented high-performance blockchain according to claim 1, wherein system deployment includes the following steps:
S1. establishing a system running environment;
S2. registering blockchain nodes;
S3. configuration of the blockchain nodes: shared memory regions are assigned to the newly registered blockchain nodes, and the configured blockchain node participates in a consensus process; in each turn of consensus achievement, the blockchain nodes elect a primary node using a shared memory-based leadership election algorithm, finally only one blockchain node successfully wins as the primary node and a block is generated, and the other blockchain nodes verify and vote for the block; the blockchain nodes in the system collaboratively decide whether to chain the block onto the blockchain based on a voting result, and in the case that a chaining condition is satisfied, the blockchain is updated locally and the system enters a next turn of consensus achievement.
